(19) United States
(12) Patent Application Publication
(10) Pub. No.: US 2008/0014012 A1
(43) Pub. Date: Jan. 17, 2008

(54) ROTARY APPLICATOR FOR COSMETIC PRODUCT

(76) Inventors: Marie Christine LE GUENIC, Sceaux (FR); Michel LIMONGI, Clichy (FR)

Correspondence Address: BANNER & WITCOFF, LTD., TEN SOUTH WACKER DRIVE, SUITE 3000, CHICAGO, IL, 60606, US

(21) Appl. No.: 11/776,402

(22) Filed: Jul. 11, 2007

(30) Foreign Application Priority Data
Jul. 12, 2006 (FR) 06/06356

(51) Int. Cl. B43M 11/02; B05C 17/02

(52) U.S. Cl. 401/219; 401/208

(57) ABSTRACT

An applicator (1) for a cosmetic product (29) comprising a handle (11) and an application nozzle (12), including at least one applicator support (13) and a thumb wheel (15), defining an application roller which is movable in rotation with respect to said applicator support (13), said thumb wheel (15) interiorly comprising a rigid core and on at least a part of its exterior surface, a transfer material (20) or a material for temporarily holding said cosmetic product (29), including a circular application surface of average thickness E, adapted to deposit said product (29) with a line of constant width during the application, said circular application surface corresponding to the larger diameter D of said thumb wheel (15), the thumb wheel (15) having a shaping factor D/E>5. The applicator provides convenient application and leads to a different aspect of the product that is applied.

### BACKGROUND OF THE INVENTION

(a) Field of the Invention

The invention concerns the field of product applicators, for example for cosmetic products, as well as that of dispensers comprising such applicators. More particularly, the invention concerns applicators used for applying cosmetic products with a large degree of preciseness.

(b) Description of the Prior Art

A large number of applicators for make-up or for face care, or for the skin in general, are already known.

Thus, for example, products in the form of agglomerated powder, which are packaged in cases, typically use brushes or foam applicators as a means for applying powder.

The applicators of the state of the art typically comprise a prehension means and an applying means adapted to allow for a transfer onto a support of the product to be applied.

As previously indicated, the applying means of the state of the art typically consist of a foam applicator or a brush, which are integral with a manual prehension means.

In use, a foam applicator or a brush loaded with a product to be applied are placed on the support (lips, eye lashes, skin, etc) and are moved on the support in a manner to leave a layer of the product thereon. As is well known, such a layer may provide a surface that is often not very homogenous and often striated as a result of the translational motion of the tip of the applicator when the product is applied.

On the other hand, in a general manner, there is a permanent need for new applicators inasmuch as when using the same product to be applied, the new applicators will provide, for example, new visual effects on the face, and also constitute a much easier way of applying the products intended to be applied.

### SUMMARY OF THE INVENTION

According to the invention, the applicator for a cosmetic product 29 intended to be applied on a part of the human body, comprises an axially directed handle 11 having a first end and a second end, and an application nozzle 12 attached to the first end, the nozzle including at least one applicator support 13 and a thumb wheel 15, both rotatably operating together to constitute a hub-axle assembly according to a rotation axis which defines an angle alpha with respect to the axial direction, the thumb wheel 15 interiorly comprising a rigid core and on at least an exterior surface portion thereof, a transfer material 20 or a material for temporarily holding the cosmetic product 29, so that a manual displacement of the applicator for a localized deposit of product 29 on the part of the human body results in a rotation of the thumb wheel 15 and in a transfer on the part of the human body of the product 29 which is present on the thumb wheel 15, and characterized in that the thumb wheel 15 comprises a circular application surface of average thickness E, which is adapted to deposit product 29 with a line of constant width during the application, the circular application surface corresponding to the larger diameter D of the thumb wheel 15, the thumb wheel 15 having a shape factor D/E>5. According to a preferred embodiment of the invention, the angle alpha is equal to zero, i.e. the axial direction and the rotation axis are parallel.

### BRIEF DESCRIPTION OF THE DRAWINGS

FIG. 1 is an axial cross-section view of an applicator having two thumb wheels 15 aligned in a same longitudinal direction, the two thumb wheels 15 rotating in a longitudinal direction of rotation.

FIG. 2a and FIG. 2b are side views of an applicator having a single thumb wheel 15 in a longitudinal direction of rotation.

FIGS. 3a to 3c are cross-section views in the plane of the axis of rotation of various thumb wheels 15 having flat ends.

FIGS. 4a to 4c are cross-section views in the plane of the axis of rotation of various thumb wheels 15 having convex ends.

FIGS. 5a to 5c are cross-section views in the plane of the axis of rotation of various thumb wheels 15 having concave ends.

FIG. 6 is an axial cross-section view of an applicator having a thumb wheel 15 in axial direction of rotation.

FIGS. 7a and 7b are transverse cross-section views in the plane of the axis of rotation of the applicators. On FIG. 7a, the applicator support 13 is formed of two studs, while in FIG. 7b, the applicator support is formed of two blind holes.

FIG. 8 represents, in cross-section in the plane of the axis of rotation, an applicator-dispenser fixed on one side to a nozzle and on the other side to an assembling means with an outlet orifice, so as to operate jointly with different reservoirs 31.

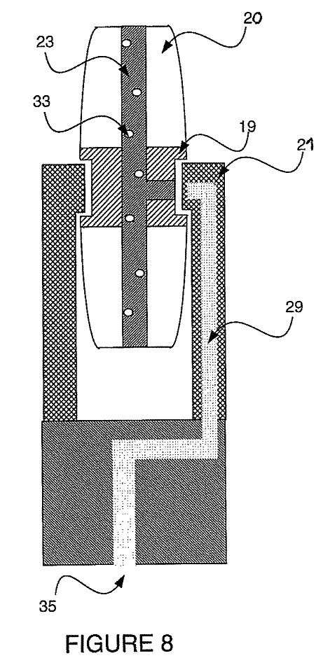

FIG. 9 is an axial cross-section view of an applicator having two thumb wheels 15 aligned in different longitudinal directions.

FIGS. 10a, 10b and 10c represent, in cross-section in the plane of the axis of rotation, different types of reservoirs to be used with an applicator-dispenser as illustrated in FIG. 8.

FIG. 11 illustrates a mode of applicator in which the thumb wheel 15 is removable.

FIG. 12A represents a thumb wheel 15 intended to be mounted on an application support 13 to constitute an applicator having a thumb wheel in longitudinal direction of rotation as illustrated in FIG. 12B, or to constitute an applicator having a thumb wheel 15 in axial direction of rotation as illustrated in FIG. 12C.

### DESCRIPTION OF PREFERRED EMBODIMENTS

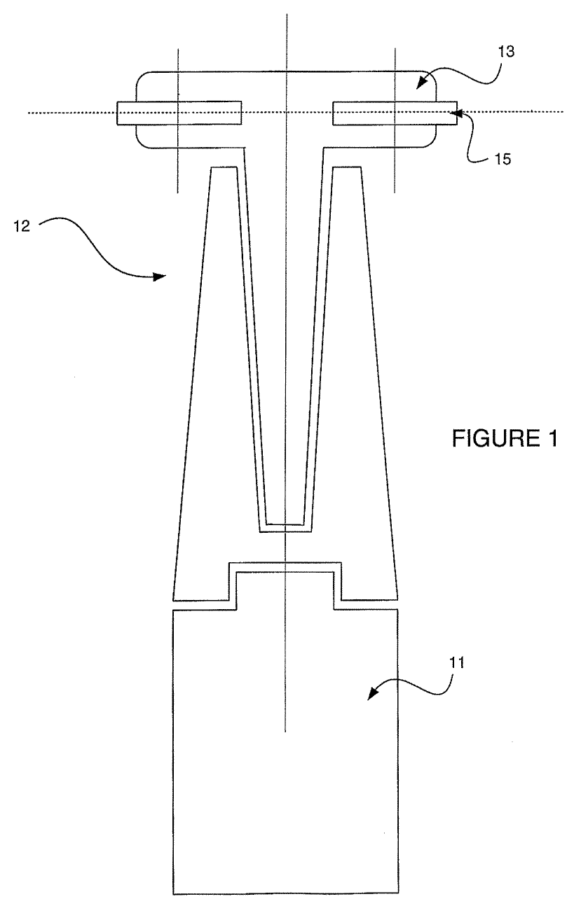

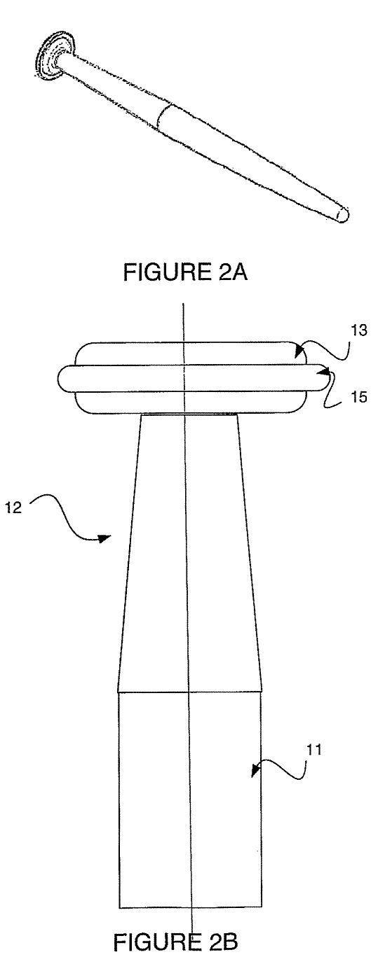

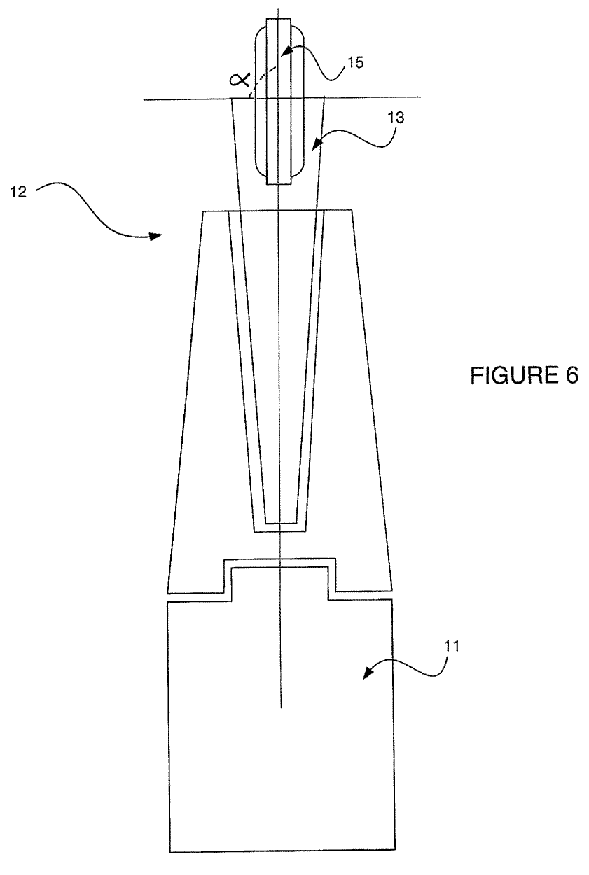

As illustrated in FIG. 1, the applicator for a cosmetic product 29 to be applied on a part of the human body, comprises an axially directed handle 11 having a first end and a second end and an application nozzle 12 attached to the first end. The nozzle 12 includes at least one applicator support 13 and a thumb wheel 15, both rotatably operating together to constitute a hub-axle assembly according to an axis of rotation which defines an angle alpha with respect to the axial direction. In FIG. 1, the angle alpha is nil, however the applicator support 13 and the thumb wheel 15 could also define an angle alpha of 90°, as illustrated, for example in the embodiment illustrated in FIG. 6. In fact, angle alpha between the applicator support 13 and the thumb wheel 15 could have any other value between 0° and 90° so as to allow for an optimal application of the cosmetic product, depending on the part of the body which is destined to receive the product. The embodiments presented in FIGS. 1 and 2 in which the thumb wheel is perpendicular to the handle, i.e. the axis of rotation of the thumb wheel and the axial direction are parallel or angle alpha is nil, are more particularly preferred since they allow for a better grabbing of the applicator and facilitate the application of the product due to the fact for example that the user's hand which holds the applicator is not in front of his eye during the application.

Thumb wheel 15 interiorly comprises a rigid core 19 and on at least part of the exterior surface, there is provided a transfer material 20 or a material for temporarily holding the cosmetic product 29, in a manner that a manual displacement of the applicator for a localized deposit of product 29 on the part of the human body results in a rotation of thumb wheel 15 and in a transfer of the product 29 which is present on thumb wheel 15 onto the part of the human body. The transfer material 20 may partially or completely cover the rigid core 19 of thumb wheel 15.

Thumb wheel 15 comprises an application surface which is circular and in which the average thickness is E, the application surface being adapted for depositing the product 29 with a line of constant width during the application. Typically, and as illustrated in FIG. 2, thumb wheel 15 may constitute a longitudinal member of shape factor D/E>5, D being the larger diameter of thumb wheel 15 and E being the thickness of the circular application surface adapted to deposit the product. In a general manner, D may typically vary between 5 and 50 mm and E may typically vary between 0.5 and 19 mm. The handle 11 of the applicator may typically vary between 20 and 150 mm. Handle 11 may be made of plastic, wood or metal.

According to a mode of the invention, the handle 11 and the application nozzle 12 are made into a single piece, while in other modes of the invention, they each constitute separate members. The applicator support 13 may be injected or machined, and this is also the case of thumb wheel 15, which may also be injected or machined.

According to an embodiment, thumb wheel 15 may be a single member of flexible material, or a lined single member.

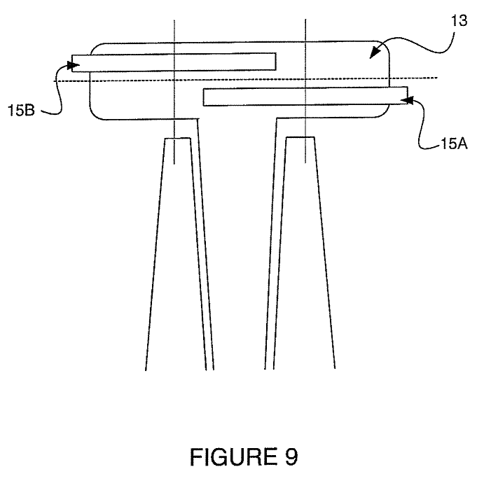

According to the embodiment of the invention illustrated in FIG. 1, the application nozzle 12 comprises two thumb wheels 15, the thumb wheels 15 being aligned along a same longitudinal direction and diametrically opposite with respect to the axial direction. According to other embodiments of the invention, and as illustrated in FIG. 9, for example, thumb wheels 15 could be distributed around the axial direction, however not necessarily along the same longitudinal direction.

According to other embodiments of the invention, the application nozzle 12 may comprise N thumb wheels 15, the thumb wheels 15 being symmetrically distributed with respect to the axial direction.

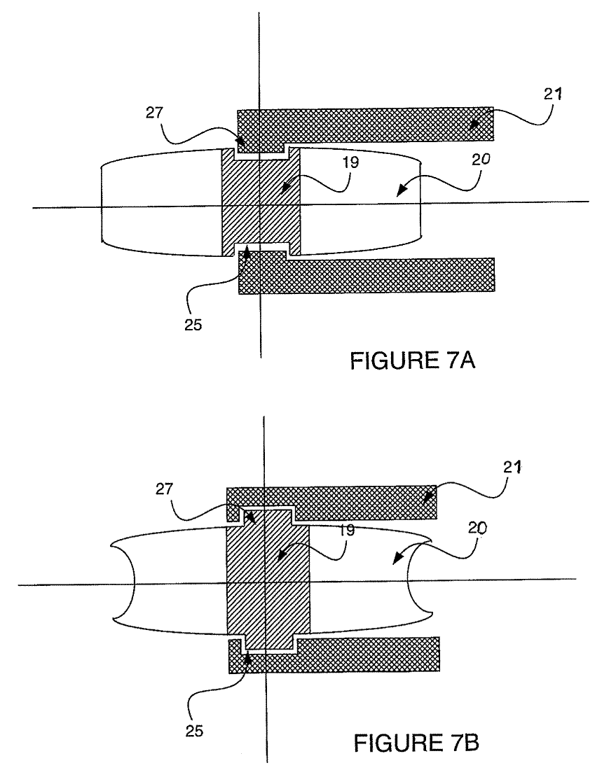

According to a first embodiment of the invention, the thumb wheel 15 may comprise the hub and the applicator support 13 comprises the axle. According to a first variant illustrated for example in FIG. 7a, the axle can operate jointly with the hub at the two axial ends of the hub, the axle typically constituting a pair of opposite studs, and the hub can define a pair of blind holes. In this case, two male members operate jointly with two female members.

According to another variant, as illustrated in FIGS. 1 and 2a and 2b, for example, the axle may operate jointly with the hub through an end of the hub, i.e. through a single side of thumb wheel 15, the axle extending along the entire or partial width of thumb wheel 15. In this case, a single male member operates jointly with a single female member.

According to a second embodiment of the invention, which is a reverse of the first embodiment, the applicator support 13 may comprise the hub and the thumb wheel 15 may comprise the axle.

According to a first variant illustrated in FIG. 7b, the hub may operate jointly with the axle at the two ends of the axle, typically through a pair of opposite blind holes. In this case, two male members operate jointly with two female members.

According to another variant, the axle may operate jointly with the hub through an end of the hub, i.e. through a single side of thumb wheel 15, the axle extending along the entire or partial thickness of the thumb wheel 15. In this case, a single male member operates jointly with a single female member.

Notwithstanding the modes or variants, thumb wheel 15 can operate jointly with applicator support 13 typically through a snapping engagement, the expression “snapping engagement” covering any situation in which two distinct members are assembled together—reversibly or irreversibly—with some tensile, compression or spreading effort exerted on at least one of the members to be assembled, this effort acting on the elasticity of the members. In this respect, it is assumed that in all the cases discussed above, the applicator support 13 and the thumb wheel 15 are snappingly engaged.

According to the invention, handle 11 may comprise means for operating jointly with a container which defines a reservoir 31 for product 29, handle 11 typically defining a cap or a plug for the reservoir in a manner to constitute an applicator-dispenser. According to another embodiment, the handle 11 can define a reservoir 31 containing product 29, in a manner to define an applicator-dispenser.

When the product is a product constituting a solid block, handle 11 may comprise a means for transferring the product, typically a spring, to apply the block against thumb wheel 15. When product 29 is a fluid product, reservoir 31 may comprise a means for transferring product 29 from the reservoir towards thumb wheel 15, a duct connecting the reservoir to the thumb wheel 15.

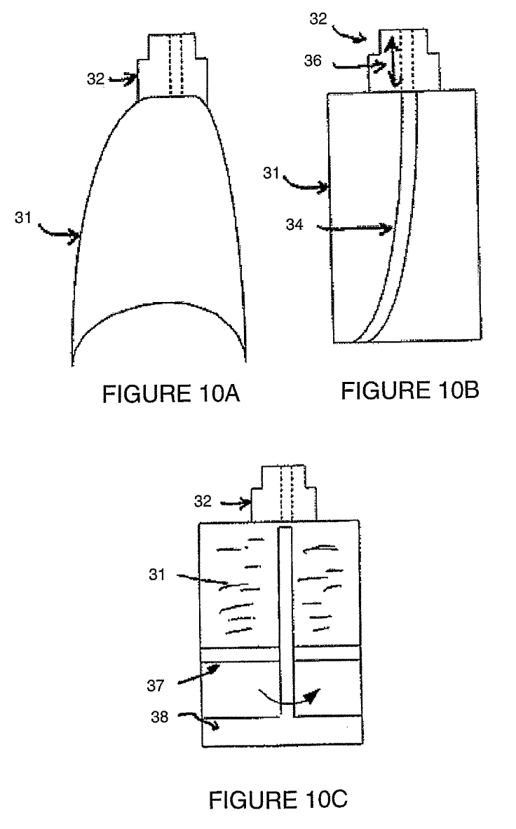

The transfer means may comprise the use of a reservoir with flexible walls adapted to be manually compressed, such as illustrated in FIG. 10b, the reservoir 31 being typically a flexible pocket or a bag, so that prehension of the reservoir can allow some one to exert a controlled pressure on the reservoir to provide for a controlled flow of the product towards the thumb wheel 15.

However, reservoir 31 can constitute a rigid body, and in this case, it is typically provided with a means for manually propelling the product. By way of example, it could be a pump 36 or a plunger 34, as illustrated in FIG. 10b or a combination comprising a piston 37 and a screw button combination 38, as illustrated in FIG. 10c.

All these reservoirs 31 are provided, typically at their upper end, with a combination means 32 also allowing for communication between the reservoir and the duct 35 or the tube.

However, it is possible to have a mere flow of the product by gravity.

Handle 11 may be fixedly connected to a reservoir 31 through a flexible or rigid connecting means, which is reversible or irreversible, typically a flexible tube, in a manner to constitute an applicator-dispenser. In this case, it is possible to dissociate handle 11 and the reservoir of product 31, which makes it possible to have on hand an object of small size and which is light, which may be advantageous when proceeding to a fine make-up.

According to the invention, thumb wheel 15 may comprise an interior rigid core 19 which constitutes the axle or the hub, and an exterior transfer material 20 or a material for temporarily holding product 29, which is unitary with the rigid core 19, in a manner to typically constitute a brush provided with bristles, or an alveolar material of foam type, or a fibrous material, such as a felt or a weaved or non weaved material, and/or a layer of elastomer.

Rigid core 19 necessarily comprises an orifice in the case of an applicator-dispenser, so as to allow for a flow of the product from reservoir 31 up to transfer material 20.

Thumb wheel 15 and/or rigid core 19 may comprise a portion provided with one or more orifices in a manner to allow for a diffusion or a homogenous distribution of the liquid product in the rotary member or into the transfer material 20.

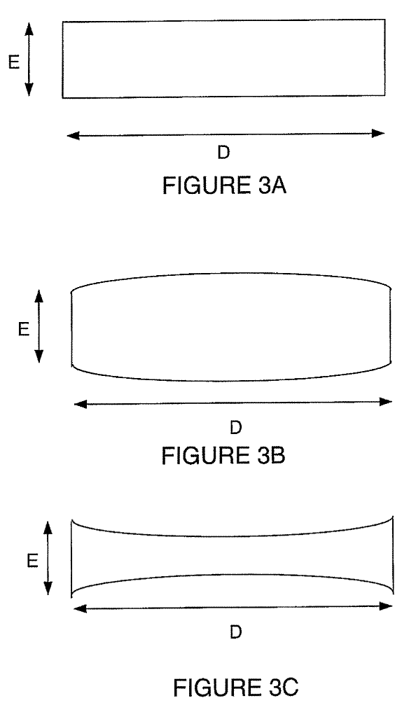

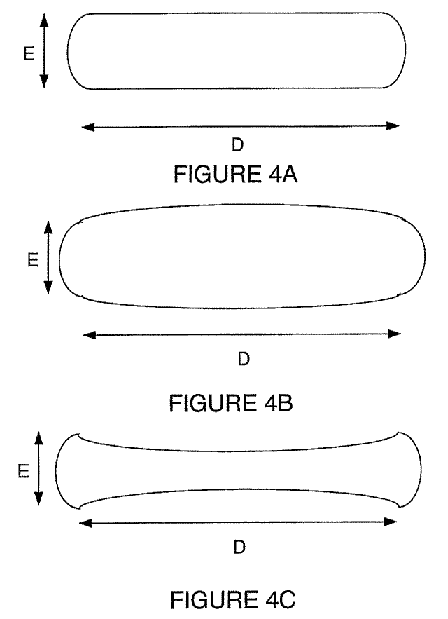

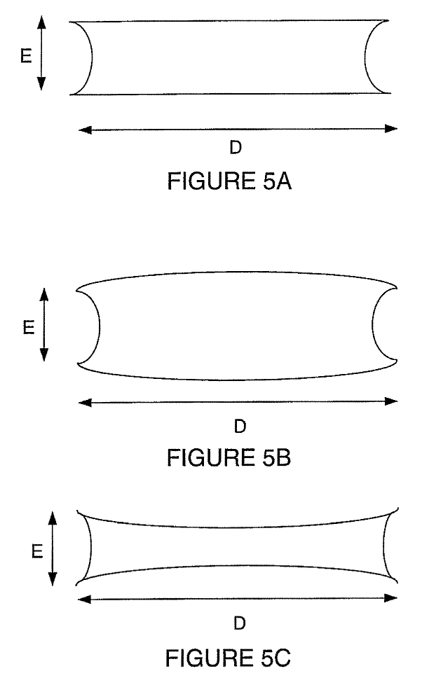

As illustrated in FIGS. 3A, 3B, 3C, in transverse cross-section, thumb wheel 15 may have an application surface E, which is essentially rectangular. As illustrated in FIGS. 4A, 4B, 4C, in transverse cross-section, thumb wheel 15 may have an application surface E, which is essentially convex, or as illustrated in FIGS. 5A, 5B, 5C, an application surface E, which is essentially concave. For each of these shapes, the application surface E may comprise at least one axial recess, or may comprise N axial recesses, which are symmetrically distributed with respect to the rotation axis.

These recesses may be filled with the product to be applied.

On the other hand, thumb wheel 15 may be provided with a set of ridges and hollows of the groove and rib type, formed on the application means itself, wherein the grooves and ribs may be parallel to one another, spirally shaped, diamond shaped, helically shaped, of cylindrical, concave, convex or conical profile.

Other shapes are naturally possible according to the invention, as long for example as curves adapted to the shape of the face and the eyes can be obtained.

Thumb wheel 15 may also comprise two distinct application materials, with a junction typically perpendicular to the rotation axis in the middle portion thereof, thumb wheel 15 being typically convex, in a manner to make it possible to use either of the distinct materials.

Handle 11 may constitute a grip with typically a swaging portion, in order to improve the ergonomics of the handle 11.

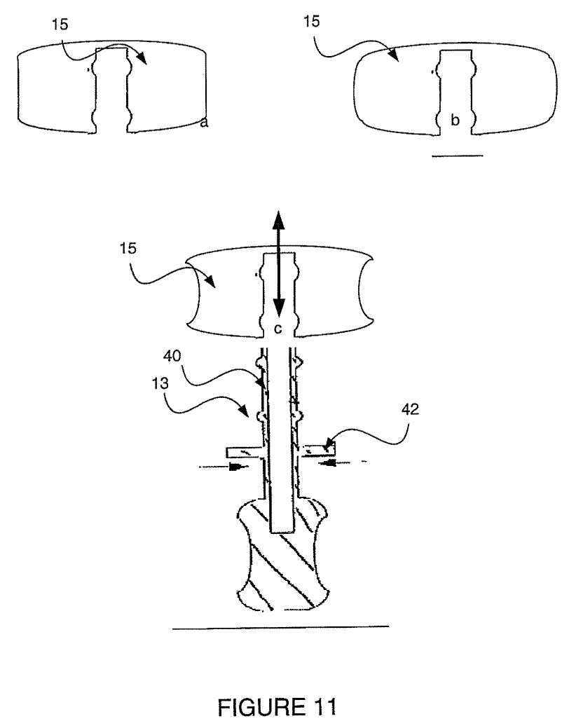

Finally, as illustrated in FIG. 11, the applicator support 13 and the thumb wheel 15 can be axially interlocked through a reversible cooperation, so as to be able to constitute an assembly comprising on the one hand, handle 11 fixed to applicator support 13 and on the other hand a series of thumb wheels 15a, 15b, 15c. In the embodiment of FIG. 11, the support of the applicator 13 comprises two flexible tongues 40, which may be compressed, for example through locking abutments 42, in a manner to free thumb wheel 15, three variants thereof having been schematically illustrated by letters a to c. In this manner, the support of the applicator 13 and the thumb wheel 15 are interlocked by means of a reversible joint operation.

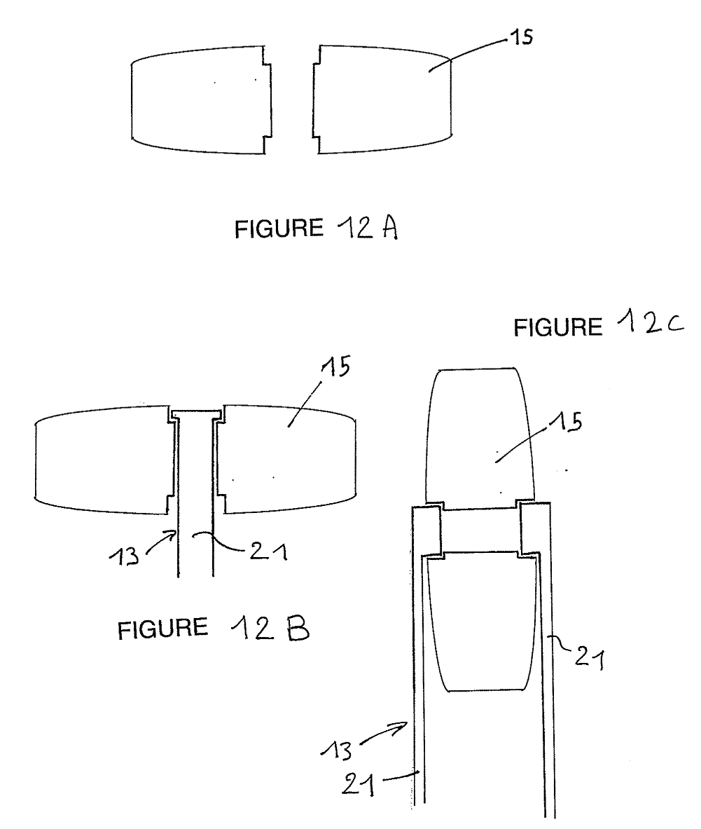

There is illustrated in FIG. 12A a thumb wheel including a mixed fixing means, i.e. defining a hub adapted to be mounted by snapping engagement on a support of the applicator 13 of the axle with one branch 21 type to constitute an applicator with a thumb wheel that is perpendicular to handle 11 and which is intended to be mounted by snapping engagement on an applicator support 13 of the axle with two branches type to constitute an applicator with a thumb wheel that is parallel to handle 11. The same thumb wheel can consequently be used with two different types of applicator, which allows for a standardization of the format and consequently represents a cost reduction. The fixing means of the axle type which is mounted on the thumb wheel is more particularly formed of a through channel which widens at the level of the opening ends in order to constitute a snapping abutment.

### ADVANTAGES OF THE INVENTION

The invention has many advantages.

Indeed, the presence of a rotary member permits on the one hand, to modify the aspect of the product that is applied as compared to a traditional application, and on the other hand, to facilitate in many cases the application while making it possible to deposit a make-up product with a line of constant width.

In addition, the applicator 10 according to the invention may have curves that are adapted to different parts of the face on which a make-up is to be applied.

Thus, for example, the applicator 10 according to FIGS. 5A, 5B, 5C will be an applicator that is adapted to the lips, since it can draw the edges of the lips while applying the product with only one application, thereby saving time, and providing for a uniform and regular application (absence of “streaks”).

Moreover, the invention offers a wide variety of modes or embodiments, so that it can be used with all sorts of products, whether they are solid or fluid, and under all sorts of conditions of use.

Finally, it makes it possible to considerably renew the offer of new products, whether we are concerned with the applicators alone or applicators-dispensers, which in practice is of a great interest.

### LIST OF REFERENCE MARKS

Applicator . . . 10
Handle . . . 11
Application nozzle . . . 12
   Applicator support . . . 13
   Thumb wheel . . . 15
   Rigid core of 15 . . . 19
   Transfer material of . . . 20
   Lateral arm . . . 21
Blind hole . . . 25
Studs . . . 27
Product . . . 29
Reservoir . . . 31
Assembling means . . . 32
Orifices of 15 . . . 33
Plunger . . . 34
Duct . . . 35
Pump . . . 36
Piston . . . 37
Screw/button assembly . . . 38

What we claim is:

1. An applicator (1) for a cosmetic product intended to be applied on a part of the human body, comprising
an axially directed handle (11) having a first end and a second end and
an application nozzle (12) attached to said first end, said nozzle including
at least one applicator support (13) and a thumb wheel (15), rotatably operating jointly to constitute a hub-axle assembly according to a rotation axis defining an angle alpha with respect to said axial direction,
said thumb wheel (15) interiorly comprising a rigid core and on at least part of its exterior surface, a transfer material (20) or a material for temporarily holding said cosmetic product (29), so that a manual displacement of said applicator for a localized deposit of said product (29) on said part of the human body results in a rotation of said thumb wheel (15) and a transfer of said product (29) that is present on said thumb wheel (15) on said part of the human body,
characterized in that:
said thumb wheel (15) comprises a circular application surface having an average thickness E, which is adapted to deposit said product (29) with a line of constant width during the application, said circular application surface corresponding to the larger diameter D of said thumb wheel (15), the thumb wheel (15) having a shape factor D/E>5.

2. Applicator according to claim 1, in which said thumb wheel (15) comprises said hub and said applicator support (13) comprises said axle.

3. Applicator according to claim 2, in which said axle operates jointly with said hub at the two axial ends of said hub, said axle typically constituting a pair of opposite studs.

4. Applicator according to claim 1, in which said thumb wheel (15) comprises said axle and said applicator support (13) comprises said hub.

5. Applicator according to claim 4, in which said hub cooperates with said axle at the two axial ends of said axle, typically through a pair of opposite blind holes (25).

6. Applicator according to any claim 1, in which said handle (11) defines a reservoir (31) containing said product (29), so as to constitute an applicator-dispenser.

7. Applicator according to claim 6, in which, said product (29) being a fluid product (29), said reservoir (31) comprises a means for transferring said product (29) from said reservoir (31) towards said thumb wheel (15), a duct (35) connecting said reservoir (31) with said thumb wheel (15).

8. Applicator according to claim 7, in which said reservoir (31) comprises a flexible wall capable of being manually compressed, said reservoir (31) typically being a flexible pocket or a bag.

9. Applicator according to claim 7, in which said reservoir (31) comprises a rigid body, typically provided with a means for manually propelling said product (29).

10. Applicator according to claim 1, in which said handle (11) is fixed to a reservoir (31) for said product (29) through a flexible or rigid connecting means, which is reversible or irreversible, typically a flexible tube, in a manner to form an applicator-dispenser.

11. Applicator according to claim 1, in which said transfer material (20) or said material for temporarily holding said cosmetic product (29) is a alveolar material of the foam type, or a fibrous material, such as a felt or a weaved or non weaved material, and/or a layer of elastomer.

12. Applicator according to claim 7, in which said thumb wheel (15) and/or said rigid core comprises a portion provided with one or more orifices (33), in a manner to ensure a distribution of said liquid homogenous product (29) into said transfer material.

13. Applicator according to claim 1, in which said thumb wheel (15) has a set of ridges and hollows of the groove and rib type formed on said application means itself, wherein said grooves and ribs could be parallel to one another, spirally shaped, diamond shaped, helically shaped, of cylindrical, concave, convex or conical profile.

14. Applicator according to claim 1, in which said handle (11) constitutes a grip with typically a swaging portion, for improving the ergonomics of the handle.

15. Applicator according to claim 1, in which said handle (11) is made of plastic, wood or metal.

16. Applicator according to claim 1, in which said handle (11) and said application nozzle (12) are unitary.

17. Applicator according to claim 1, in which said angle alpha is 90° in a manner that the rotation axis of said thumb wheel (15) is perpendicular to said axial direction.

18. Applicator according to claim 1, in which said angle alpha is 0° in a manner that the axis of rotation of said thumb wheel (15) is parallel to said axial direction.

19. Applicator according to claim 1, in which said applicator support (13) and said thumb wheel (15) are axially connected through a reversible joint operation, in a manner to be able to form a combination comprising on the one hand, said handle (11) fixed to said applicator support (13) and on the other hand a series of interchangeable thumb wheels (15).

20. Applicator according to claim 1, in which said application nozzle (12) comprises two thumb wheels (15), said thumb wheels (15) being aligned along a same longitudinal direction and being diametrically opposed with respect to said axial direction.

21. Applicator according to claim 1, in which said application nozzle (12) comprises N thumb wheels (15), said thumb wheels (15) being distributed symmetrically with respect to said axial direction.

22. Applicator according to claim 1, in which said thumb wheel (15) operates jointly with said applicator support (13) by snapping.
